(19) United States
(12) Patent Application Publication
(10) Pub. No.: US 2011/0100336 A1
(43) Pub. Date: May 5, 2011

(54) VAPOR RECOVERY SYSTEM HAVING VACUUM BREAK FITTING WITH FLOW RESTRICTOR

(76) Inventors: Thomas R. Genz, Lake Mills, WI (US); Robert J. Loehr, Kewaskum, WI (US)

(21) Appl. No.: 12/612,358

(22) Filed: Nov. 4, 2009

(51) Int. Cl. F02M 25/08; F02M 33/02

(52) U.S. Cl. 123/518

(57) ABSTRACT

A vapor recovery system between a fuel tank and an engine intake manifold includes a T-fitting to provide a vacuum break. The first and second ends of the T-fitting are connected in line with a vapor recovery hose, and the third end draws outside air into the T-fitting and may have a filter attached thereto. A flow restrictor also is provided in the first end of the T-fitting, to limit the flow of vapor from the fuel tank and maintain adequate vapor space in the tank.

### FIELD OF THE INVENTION

This invention relates to a vapor recovery system for an internal combustion engine used to power lawn and garden equipment, and more specifically to a vapor recovery system having a vacuum break fitting with a flow restrictor.

### BACKGROUND OF THE INVENTION

Lawn and garden equipment, including but not limited to grass mowing machines, typically is powered by internal combustion engines with fuel systems having a vented filler cap and a crankcase-pulse-driven fuel pump. A vented filler cap provides make-up air to a fuel tank as the fuel pump draws fuel from the tank, equalizing the fuel tank pressure to nearly atmospheric pressure. In recent years, active evaporative loss control of fuel vapors also is required, necessitating the use of a vapor recovery system in which the vapors are consumed by the engine during machine operation.

The connection of a vapor recovery hose from the fuel tank to the engine may be designed to have a pressure differential that will cause vapor flow from the tank to the engine. However, in some cases the vacuum delivered through the vapor recovery hose by the engine intake manifold exceeds the fuel pump's ability to draw, causing a break in the vacuum. This break in vacuum may be prevented by a vented filler cap, but this also has the disadvantage of drawing very large volumes of unfiltered air across the fuel, leading to contamination of the fuel with debris and water vapor. Additionally, the requirement that a fuel tank must provide for vapor collection requires vapor space to be maintained within the fuel tank, especially during tank refill.

A vapor recovery system for lawn and garden equipment is needed that can minimize contamination of debris and water vapor in a fuel tank, that can maintain vapor space in the fuel tank, and that can direct fuel vapor to the engine intake manifold.

### SUMMARY OF THE INVENTION

A vapor recovery system includes a vacuum break fitting in a vapor recovery hose connected between a rollover valve in the fuel tank and the engine intake manifold of a grass mowing machine or other lawn and garden equipment. A flow restrictor is provided in one end of the vacuum break fitting to limit vapor flow. A filter is provided on the end of the vacuum break fitting that draws outside air into the vacuum break fitting. A filler neck extends into the fuel tank below the rollover valve.

The vapor recovery system enables use of a sealed cap which minimizes contamination of debris and water vapor in a fuel tank. The vacuum break fitting and flow restrictor also help maintain vapor space in the fuel tank while directing vapor to the engine intake manifold in compliance with regulatory requirements.

### BRIEF DESCRIPTION OF THE DRAWINGS

FIG. 1 is a cross section view of a vapor recovery system having a vacuum break fitting with a flow restrictor according to a first embodiment of the invention.

FIG. 2 is an exploded view of a vacuum break fitting with a flow restrictor according to a first embodiment of the invention.

### DESCRIPTION OF THE PREFERRED EMBODIMENT

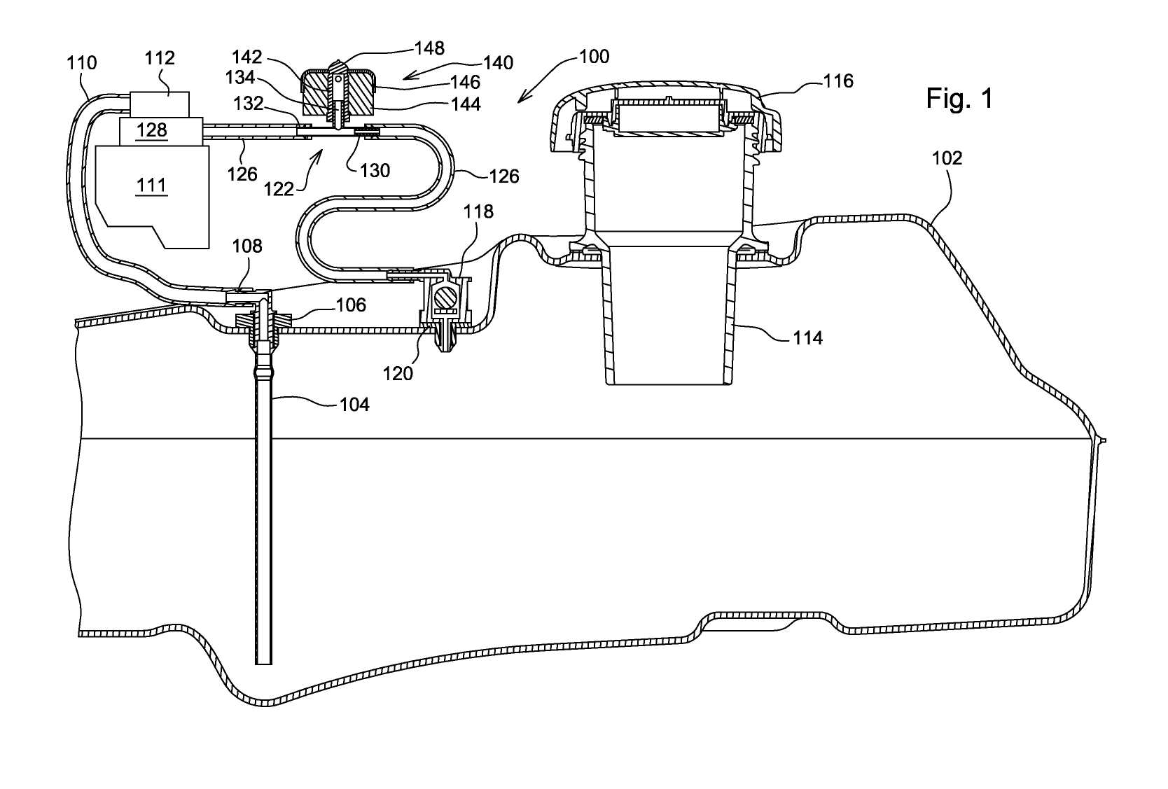

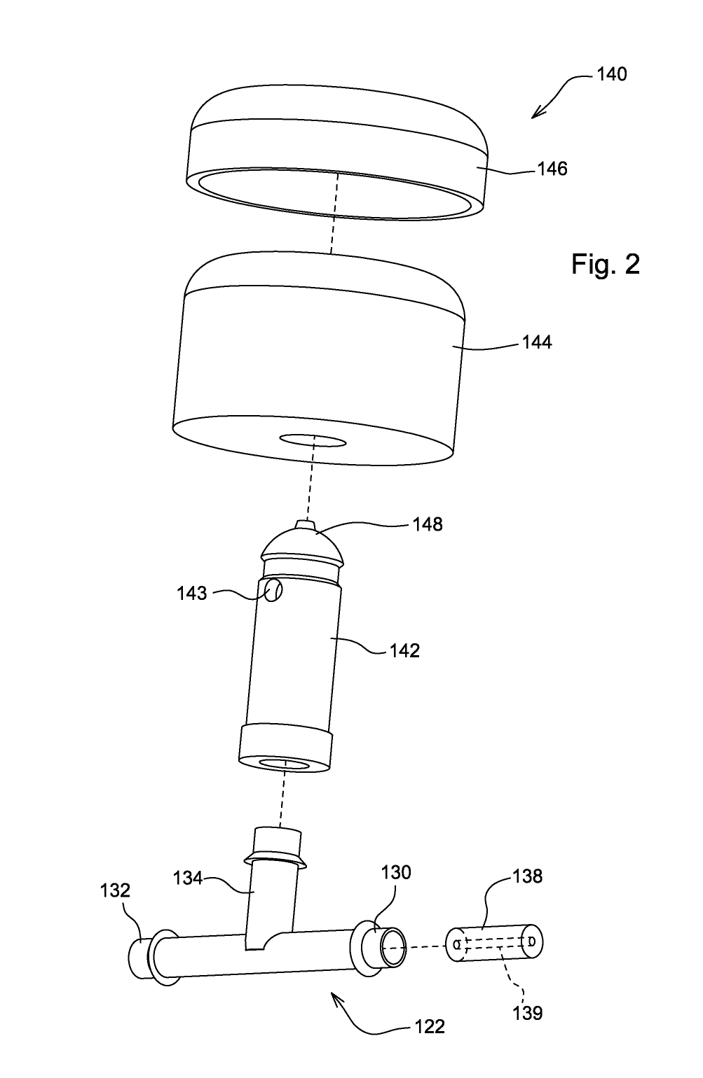

FIGS. 1 and 2 show an embodiment of vapor recovery system 100 for a grass mowing machine or other lawn and garden equipment having a fuel tank 102 and internal combustion engine 111. The fuel tank may include fuel pickup tube 104 attached with fitting 106 extending through an opening in the top of the fuel tank so the fuel pickup tube extends downwardly inside the tank. The lower end of the fuel pickup tube preferably reaches into a cavity or recess at or near the bottom of the fuel tank. Conduit 108 may extend out from fitting 106 and may be attached to fuel line or hose 110 connected to carburetor 112 of the internal combustion engine through a filter and fuel pump (not shown) to supply fuel to the engine in response to a throttle or other operator control.

In one embodiment, fill neck 114 extends through and is secured to the fuel tank to form a seal with an opening in the top of the fuel tank. The fill neck extends downwardly from the opening into the tank interior. Sealed filler cap 116 may be removably attached and sealed to the top of the fill neck with engaging threads and one or more seals so that fuel vapor cannot escape.

In one embodiment, fuel vapor may exit the fuel tank through rollover valve 118. The rollover valve may be sealed with a grommet or fitting 120 in an opening through the top of the fuel tank. The rollover valve is designed to open to allow vapor to exit the fuel tank, and to close to prevent liquid fuel flowing out of the tank if the grass mowing machine and/or tank is tipped excessively or overturned.

In one embodiment, the vapor recovery system includes vacuum break fitting 122 which may be provided in vapor recovery hose 126 between rollover valve 118 and engine intake manifold 128. The vacuum break fitting may be a T-fitting with first and second ends 130, 132 secured in line with vapor recovery hose 126, and third end 134 bisecting the first and second ends that may draw outside air into the vacuum break fitting. Each end of the vacuum break fitting may be sized to accept and attach to a 3/16 inch i.d. hose or tube.

In one embodiment, the vapor recovery system includes flow restrictor 138 in the first end 130 of vacuum break fitting, i.e., the end facing the rollover valve and fuel tank. The flow restrictor has an orifice 139 with an inner diameter (i.d.) that is preferably between about 0.015 inches and about 0.025 inches, and most preferably is about 0.020 inches.

In one embodiment, the vacuum break fitting with flow restrictor minimizes debris and water contamination of the fuel system. It may be used with the sealed filler cap to satisfy requirements for vapor recovery while allowing pressure equalization in the fuel tank. The flow restrictor in the vacuum break fitting helps maintain vapor space within the fuel tank, while maintaining a vapor flow path from the tank to the engine intake manifold. The flow restrictor's narrow orifice limits the flow from the vapor space in the tank out through vapor recovery hose 126 to the engine intake manifold. As a result, vapor pressure in the fuel tank prevents filling the tank above the lower end of filler neck 114. Once the fuel level reaches the filler neck, any additional fuel may be limited to the volume of the filler neck. This limitation makes it difficult or impossible to overfill the fuel tank.

Additionally, in one embodiment, vapor recovery hose 126 and vacuum break fitting 122 may be attached to rollover valve 118 at a location higher than the lower end of the filler neck. Once the fuel level reaches the filler neck, pressure in the vapor space prevents the fuel level from rising further so the fuel cannot reach the rollover valve.

In one embodiment, filter 140 may be provided on the third end of the vacuum break fitting to clean outside air that is drawn into vacuum break fitting 122. The filter may include sleeve 142 with opening 143 connected to the third end of the vacuum break fitting, surrounded by foam cylinder 144. Rubber cap 146 may hold the foam cylinder in place by engaging a groove below the top 148 of the sleeve.

Having described the preferred embodiment, it will become apparent that various modifications can be made without departing from the scope of the invention as defined in the accompanying claims.

1. A vapor recovery system, comprising:
a vapor recovery hose connected between a fuel tank and an engine intake manifold;
a T-fitting with first and second ends connected in line with the vapor recovery hose and a third end to draw outside air into the T-fitting and having a filter attached thereto to filter the outside air; and
a flow restrictor in the first end of the T-fitting.

2. The vapor recovery system of claim 1 further comprising a filler neck extending into the fuel tank below where the vapor recovery hose is connected to the fuel tank.

3. The vapor recovery system of claim 1 further comprising a rollover valve at the connection of the vapor recovery hose to the fuel tank.

4. The vapor recovery system of claim 1 wherein the flow restrictor has an inner diameter of between 0.015 inches and 0.025 inches.

5. The vapor recovery system of claim 1 further comprising a sealed filler cap threaded to the filler neck.

6. A vapor recovery system, comprising:
a vacuum break fitting in a vapor recovery hose connected to a rollover valve in a fuel tank;
a flow restrictor in the vacuum break fitting limiting vapor flow through the vacuum break fitting; and
a filter over an end of the vacuum break fitting that draws outside air into the vacuum break fitting.

7. The vapor recovery system of claim 6 further comprising a filler neck extending into the fuel tank to a location below the rollover valve.

8. The vapor recovery system of claim 7 further comprising a sealed filler cap removably connected to the filler neck.

9. The vapor recovery system of claim 6 wherein the vapor recover hose is connected to an engine intake manifold.

10. A vapor recovery system, comprising:
a T-fitting having a first end with a flow restrictor connected to a vapor recovery tube to a fuel tank;
a second end connected to a vapor recovery tube to an engine intake manifold; and
a third end bisecting the first and the second ends to draw filtered air into the T-fitting.

12. The vapor recovery system of claim 10 wherein the flow restrictor is an orifice having an inner diameter between 0.015 inches and 0.025 inches.
